(19) United States
(12) Patent Application Publication
(10) Pub. No.: US 2005/0119118 A1
(43) Pub. Date: Jun. 2, 2005

(54) Water gas shift catalyst for fuel cells application

(76) Inventors: Troy L. Walsh, Louisville, KY (US); David B. Rogers, Louisville, KY (US); Michael W. Balakos, Buckner, KY (US); Michelle R. Madden, Louisville, KY (US)

Correspondence Address: SUD-CHEMIE INC., 1600 WEST HILL STREET, LOUISVILLE, KY, 40210, US

(21) Appl. No.: 10/726,147

(22) Filed: Dec. 2, 2003

(51) Int. Cl. B01J 23/00; C01B 3/26

(52) U.S. Cl. 502/303; 423/652

(57) ABSTRACT

A stable water gas shift catalyst comprising platinum, rhenium and lanthanum on a high surface area rutile titanium dioxide support is described. The catalyst of the present invention is at least as efficient in converting CO to CO₂ at low temperatures as the catalysts of the prior art. Further, the catalyst is about three times more stable than the catalysts of the prior art.

### BACKGROUND OF THE INVENTION

The present invention is directed to a water gas shift catalyst for fuel cell applications and to a process of making and using such catalyst. In particular, the present invention is directed to a catalyst with a catalytically-active component of platinum or a combination of platinum and rhenium on a titanium dioxide carrier containing a lanthanum compound, a cerium compound, or a combination of lanthanum and cerium for the conversion of carbon monoxide and steam into carbon dioxide and hydrogen.

Generating electrical power with the use of proton-exchange membrane or solid polymer electrolyte fuel cells is known and is expected to ultimately have widespread use in automobiles, small appliances, or anything that is or can be powered with electricity. Fuel cells are more efficient than traditional hydrocarbon combustion engines and produce almost no emissions other than water. Therefore, fuel cells are a highly desirable energy source.

Hydrogen gas feeds the fuel cell. Some typical hydrogen gas sources are oil, natural gas, methanol or other hydrogen-rich compounds. These hydrogen sources are processed to break down the molecules of hydrocarbons and produce a H₂-rich gas stream. Some typical processes employ steam reforming, autothermal reforming, non-catalytic partial oxidation of light hydrocarbons or non-catalytic partial oxidation of any hydrocarbons. In addition to hydrogen being produced by these reactions, carbon monoxide and carbon dioxide is also produced and enters the hydrogen-rich gas stream. In fact, carbon monoxide may be present in the gas stream at concentrations in excess of 10%.

Fuel cells function by having the hydrogen enter the fuel cell at the anode end and where it is stripped of electrons and leaving only the protons. The protons then carry the positive charge while the stripped electrons provide an electrical current to do work. The anodic reaction is as follows:
H₂→2H⁺+2e⁻

Oxygen, the source of which is typically air, enters the fuel cell at the cathode end and combines with the electrons and the protons generated at the anode to produce water. The cathodic reaction is as follows:
½O₂+2H⁺+2e⁻→H₂O

The overall reaction is the oxidation of hydrogen which generates the electrical current to do work and is as follows:
H₂+½O₂→H₂O

The electrodes (anode and cathode) in the fuel cell use catalysts in order to accelerate their respective reaction. These catalysts usually include platinum and/or a variety of alloys of platinum. The platinum-containing anode in the fuel cell may become poisoned with a high level of carbon monoxide (approximately 50 ppm on a dry basis), resulting in decreased electrical output of the fuel cell. Also, a proton-exchange membrane—used for the cathodic reaction—may be damaged by impurities in the hydrogen feed gas. Therefore, it is necessary for the hydrogen gas being fed to the anode to have low concentrations of carbon monoxide and other impurities.

The reduction of carbon monoxide is typically accomplished in a shift converter where the hydrogen-rich gas further comprising carbon monoxide, carbon dioxide, and water is contacted with a catalyst. The reaction that takes place in the shift converter is commonly referred to as a water gas shift reaction and is represented by the following equation:
CO+H₂O⇄CO₂+H₂
The water gas shift reaction results in the reduction of the carbon monoxide concentration, thereby reducing the probability that the anode will be poisoned with carbon monoxide, and increases the hydrogen concentration of the fuel cell feed gas.

As is known in the art, the water-gas-shift reaction is believed to proceed either through an associative mechanism or through a regenerative mechanism. According to the associative mechanism, the active metal of the catalyst reacts with water causing the water molecule to dissociate on the metal surface into a hydroxyl group and a hydrogen atom. The hydroxyl group can then react with adsorbed carbon monoxide to generate a formate ligand. The formate ligand can decompose to release carbon dioxide leaving a hydrogen atom associated with the metal. The hydrogen from the formate can then combine with the hydrogen from the water to produce hydrogen gas (H₂). According to the regenerative mechanism, water oxidizes on the active metal surface releasing hydrogen gas (H₂) and leaving the oxygen associated with the metal. Adsorbed carbon monoxide can react with the metal-oxygen complex to produce carbon dioxide. (For a more detailed review of the proposed mechanisms for the water-gas-shift catalyst, see for example “Steam Effects in Three-Way Catalysis,” authored by J. Barbier Jr., and D. Duprez, Applied Catalysis B: Environmental, 4, 105 (1994) and the references cited therein, incorporated herein by reference.)

Typically, the catalysts used in the industrial scale water-gas-shift reaction include either an iron-chromium (Fe—Cr) metal combination or a copper-zinc (Cu—Zn) metal combination. The Fe—Cr oxide catalyst works extremely well in a two stage CO conversion system for ammonia synthesis and in industrial high temperature shift (HTS) converters. However, in single stage converters the Fe—Cr oxide catalysts are not as effective and the CO level is only reduced to about 1%.

The copper-based catalysts function well in systems where the CO₂ partial pressure can affect the catalyst performance. It is known that the CO₂ partial pressure in the reacting gas exerts a retarding effect on the forward rate constant, but over copper based catalysts the effect is negligible. Therefore, copper-based catalysts demonstrate more favorable CO conversion at lower temperatures. However, the unsupported metallic copper catalysts or copper supported on Al₂O₃, SiO₂, MgO, pumice or Cr₂O₃ tend to have relatively short lifespans (six to nine months) and low space velocity operation (400 to 1000 h⁻¹). The addition of ZnO or ZnO—Al₂O₃ can increase the lifetime of the copper-based catalysts, but the resultant Cu—Zn catalysts generally function in a limited temperature range of from about 200° C. to about 300° C.

Although Fe—Cr and Cu—Zn catalysts are efficient when used in a commercial facility, they are not readily adaptable for use in stationary fuel cell power units or mobile fuel cells. For example, the catalysts used in the fuel cell reformer must have a high level of activity under high space velocity operation conditions because relatively large volumes of hydrocarbons are passed over the catalyst bed in a relatively short period of time. Moreover, the catalyst bed volume must be extremely small as compared to a commercial facility: a typical commercial facility uses reformer catalyst beds having average volumes ranging from about 2 m³ to about 240 m³, whereas stationary fuel cell reformer catalyst bed volumes are around 0.1 m³ and mobile fuel cell catalyst beds have volumes of about 0.01 m³. Further, the mobile fuel cell catalyst must be capable of retaining activity after exposure to condensing and oxidizing conditions during a large number of startup and shutdown cycles, and the catalyst must not require a special activation procedure or generate substantial heat when switching from reducing to oxidizing conditions at elevated temperatures. The mobile fuel cell catalyst must also tolerate an oxygen rich atmosphere in contrast to the Cu—Zn catalysts which are self-heating solids and which require steam removal and a nitrogen blanket upon reactor shut-down to minimize condensation formation and related deactivation. Because the hydrocarbon source for fuel cells may include contaminating materials such as sulfur, the catalyst should also have a relatively high poison resistance.

A representative catalyst for use in fuel cells is taught in U.S. 2003/0195115A1, assigned to Mitsubishi Electric Works and published on Oct. 16, 2003. The catalyst of the '115 application comprises platinum and rhenium on a rutile titanium dioxide support. This catalyst demonstrates a high CO conversion at a relatively low temperature (200° C. to 300° C.), but is not a highly stable catalyst.

Thus, it is an object of the present invention to provide a more stable catalyst that is capable of selectively removing carbon monoxide and increasing the hydrogen concentration in the hydrogen rich gas stream by way of the water gas shift reaction. Specifically, the concentration of carbon monoxide in a hydrogen rich feed gas is to be reduced to a level under 50 ppm on a dry basis and to improve the water gas shift equilibrium toward the carbon dioxide side of the reaction at a relatively low temperature.

### SUMMARY OF THE INVENTION

The present development is a catalyst for use in the water-gas-shift reaction. The catalyst comprises platinum, rhenium and lanthanum on a high surface area rutile titanium dioxide containing carrier. Optionally, cerium, zirconium, tungsten, molybdenum or a combination thereof may be added to the carrier to improve the stability of the catalyst.

The total weight percent of the active metals—platinum and rhenium—is about 20 wt %. The platinum and rhenium preferably have a relative weight ratio of from about 1 Pt:0.9 Re to about 5 Pt:1 Re. The lanthanum is preferably present at a concentration of from about 0.1 wt % to about 20 wt %, and may be added to the catalyst by a variety of means known in the art, and preferably is added as a sol. The catalyst of the present invention is more resistant to CO poisoning and more stable than the prior art catalysts.

### DETAILED DESCRIPTION OF THE INVENTION

The catalyst of the present invention is intended for use as a water-gas-shift (WGS) catalyst for fuel cell applications. The catalyst composition comprises platinum, rhenium and lanthanum on a support containing titanium dioxide. The support is preferably a high surface area rutile titanium dioxide. The resulting catalyst is capable of selectively removing carbon monoxide and increasing the hydrogen concentration in the hydrogen rich gas stream by way of the water gas shift reaction and is more stable than the catalysts of the prior art.

The term “weight percent (wt %)” as used herein refers to the relative weight each of the above specified components contributes to the combined total weight of those components. As is known in the art, catalysts may be loaded onto a variety of substrates depending on the intended application. The present catalyst may similarly be delivered on a variety of substrates, such as monoliths, foams, spheres, or other forms as are known in the art. When delivered in these forms and for the purposes of illustration herein, unless otherwise noted, any weight added by the substrate is not included in the wt % calculations.

The present invention can be illustrated and explained through a series of examples presented herein, which are not to be taken as limiting the present invention in any regard. Unless otherwise stated, all raw materials specified in the examples are commercially available and reference to a particular supplier is merely exemplary.

The catalyst support comprises a high surface area rutile TiO₂ wherein the rutile TiO₂ has a surface area greater than about 10 m²/g, and more preferably greater than about 30 m²/g. The titanium dioxides are commercially available from a variety of chemical suppliers, such as Matsushita Electric Works.

Lanthanum is added to the support such that lanthanum concentration in the finished catalyst is from about 0.1 wt % to about 20 wt %. The lanthanum may be added to the titanium dioxide by any method known in the art. For example, the lanthanum may be added as a lanthanum sol. Although not a requirement to practice the invention, it is recommended that the lanthanum source be free of typically recognized poisons, such as sulfur, chlorine, sodium, bromine, iodine or combinations thereof. Acceptable catalyst can be prepared using lanthanum sources that include such poisons, but care must be taken to wash the poisons from the catalyst during production of the catalyst.

The platinum and rhenium are preferably present at a combined concentration of up to about 20 wt %, wherein platinum is present at a higher concentration than rhenium and the relative concentrations vary from about 1 Pt:0.9 Re to about 5 Pt:1 Re. Similar to lanthanum, the platinum and rhenium may be added to the catalyst by any method known in the art, and it is recommended that the metal source be free of typically recognized poisons. Without limitation, some example sources of platinum are platinum tetra-amine hydroxide, platinum tetra-amine nitrate, platinum di-amine nitrate, platinum oxalate, platinum nitrate, chloroplatinic acid; some examples of rhenium are perrhenic acid, ammonium perrhenate, rhenium oxide complexes, such as ReO₂, ReO₃, Re₂O₇.

Optionally, an additive, such as cerium, zirconium, tungsten, molybdenum, {lanthanum?} or a combination thereof, may be added to the support at a concentration of from about 0 wt % to about ______ wt %. Similar to lanthanum, the additional metal may be added to the catalyst by any method known in the art, and it is recommended that the metal source be free of typically recognized poisons. For example, cerium may be added to the catalyst as a sol of cerium nitrate, cerium oxide or cerium acetate.

Methods for preparing the catalysts are known in the art. The following examples are provided to illustrate representative preparations of catalysts of the present invention.

### EXAMPLE 1

The rutile TiO₂ powder is densified by mixing with water and drying the mixture over a steam bath and then calcining at about 500° C. for 4 hours. The loss-on-ignition (LOI) of the rutile TiO₂ powder is checked by measuring the weight loss after heating the support to 520° C. for about 2 hours and is found to be 1.73. The water-pickup is measured by adding water to a known amount of calcinated powder until the powder is wet, and then dividing the weight of the water added by the weight of the powder, and is calculated to be 0.70 g H₂O/g TiO₂. Based on the LOI of the powder, a 100 g catalyst sample is prepared by mixing about 86.84 g rutile TiO₂ with about 50.00 g La₂O₃ solution (the La sol is commercially available from Nyacol, about 20% La₂O₃) and adding about 10.79 g water to the TiO₂ powder drop wise while mixing with a stirring rod until all the solution has been added and a paste is formed. The paste is stirred and dried over a steam bath. After the paste is dried, it is placed in a muffle furnace and calcined at about 500° C. for about 2 hours. About 30.00 g Pt solution (as tetra-amine platinum hydroxide from Colonial Metals, 10 wt % Pt) plus about 30.79 g water is added drop wise to the dried paste with continuous stirring and the resulting solution is dried over a steam bath and placed in a muffled furnace and calcined at about 440° C. for about two hours. About 5.0 g Re solution (as perrhenic acid from Colonial Metals, 20 wt % Re) is mixed with about 55.79 g H₂O is then added drop wise to Pt-containing material with continuous stirring. The Re-containing solution is then dried over a steam bath and placed in a muffled furnace and calcined at about 440° C. for about two hours. The resulting catalyst comprises about 86 wt % rutile TiO₂, about 10 wt % La₂O₃, about 3 wt % Pt and about 1 wt % Re.

### EXAMPLE 2

A catalyst is prepared according to the procedure of Example 1 except that about 25.00 g CeO₂ sol and about 35.79 g water is added to the TiO₂ powder before the addition of the La₂O₃. After the CeO₂ addition, the mixture is dried over a steam bath and placed in a muffle furnace and calcined at about 500° C. for about two hours. About 25.00 g La₂O₃ sol and about 35.79 g water is then added to the CeO₂ mixture, the solution is dried over a steam bath, placed in a muffle furnace and calcined at about 500° C. for about two hours. About 30.00 g Pt solution mixed with about 30.79 g water is added drop wise to the lanthanum-containing mixture, the solution is dried over a steam bath, placed in a muffle furnace and calcined at about 440° C. for about two hours. About 5.0 g Re solution mixed with 55.79 g water is then added drop wise to the Pt-containing material with continuous stirring. The Re-containing mixture is then dried over a steam bath and placed in a muffle furnace and calcined at 440° C. for two hours. The resulting catalyst comprises about 86 wt % rutile TiO₂, about 5 wt % CeO₂, about 5 wt % La₂O₃, about 3 wt % Pt and about 1 wt % Re.

### EXAMPLE 3

A catalyst is prepared according to the procedure of Example 1 except that about 91.00 g TiO₂ powder and about 25.00 g La₂O₃ sol (Rhodia Electronics and Catalysis) solution is used in place of the original 86.84 g TiO₂ powder and 50.00 g La₂O₃ solution. The resulting catalyst comprises about 91 wt % rutile TiO₂, about 5 wt % La₂O₃, about 3 wt % Pt and about 1 wt % Re.

### EXAMPLE 4

A catalyst is prepared according to the procedure of Example 1 except that about 50.00 g CeO₂ sol (from Nyacol) plus about 10.79 g water is used in place of the original 50.00 g La₂O₃ solution plus about 10.79 g water. The resulting catalyst comprises about 86 wt % rutile TiO₂, about 10 wt % CeO₂, about 3 wt % Pt and about 1 wt % Re.

### EXAMPLE 5

A catalyst is prepared according to the procedure of Example 1 except that about 84.49 g TiO₂ powder and about 35.71 g CeNO₃ solution (28% Ce) plus about 25.07 g water is used in place of the original 50.00 g La₂O₃ solution plus about 10.79 g water. The resulting catalyst comprises about 86 wt % rutile TiO₂, about 10 wt % Ce, about 3 wt % Pt and about 1 wt % Re.

The catalysts are tested by contacting a gas comprising about 6.2% CO, 11.0% CO₂, 2.8% N₂, 31.0% H₂O, and 49.0% H₂ with the catalyst at a space velocity of 350,000/hr under 10 psig pressure. The catalysts of the present invention are at least as efficient in converting CO to CO₂ as the catalysts of the prior art, and are particularly efficient as compared to the prior art catalysts for low-temperature conversions, e.g. at temperatures from about 225° C. to about 275° C. Further, the catalysts that comprise lanthanum oxide are about three times more stable than the catalysts of the prior art.

It is understood that variations may be made which would fall within the scope of this development. For example, although the catalysts of the present invention are intended for use as water-gas-shift (WGS) catalyst for fuel cell applications, it is anticipated that these catalysts could be used in other applications requiring water-gas-shift catalysts that are stable and active at relatively low temperatures.

1. A water gas shift catalyst comprising platinum, rhenium and lanthanum on a high surface area rutile titanium dioxide support.

2. The catalyst of claim 1 wherein said rutile TiO₂ has a surface area greater than about 10 m²/g.

3. The catalyst of claim 2 wherein said rutile TiO₂ has a surface area greater than about 30 m²/g.

4. The catalyst of claim 1 wherein said lanthanum is present in the form of La₂O₃ and comprises from about 0.1 wt % up to about 20 wt % of the catalyst.

5. The catalyst of claim 1 wherein said platinum plus said rhenium comprise about 20 wt % of said catalyst.

6. The catalyst of claim 1 wherein said platinum is present at a higher concentration than said rhenium.

7. The catalyst of claim 3 wherein said platinum to rhenium ratio is from about 1 Pt:0.9 Re to about 5 Pt:1 Re.

8. The catalyst of claim 7 wherein said platinum:rhenium ratio is about 3:1.

9. The catalyst of claim 1 further comprising an additive selected from the group consisting of cerium, molybdenum, zirconium, tungsten and a combination thereof.

10. The catalyst of claim 9 wherein said additive is present at a concentration of up to about 20 wt % in the catalyst.

11. A water gas shift catalyst comprising platinum, rhenium and lanthanum on a rutile titanium dioxide support wherein said support has a surface area greater than about 30 m²/g.

12. The catalyst of claim 11 wherein said lanthanum is present in the form of La₂O₃ and comprises from about 0.1 wt % up to about 20 wt % of the catalyst.

13. The catalyst of claim 11 wherein said platinum plus said rhenium comprise about 20 wt % of said catalyst.

14. The catalyst of claim 11 wherein said platinum is present at a higher concentration than said rhenium and said platinum to rhenium ratio is from about 1 Pt:0.9 Re to about 5 Pt:1 Re.

15. The catalyst of claim 11 further comprising an additive selected from the group consisting of cerium, molybdenum, zirconium, tungsten and a combination thereof, and wherein said additive is present at a concentration of up to about 20 wt % in the catalyst.

16. A water gas shift catalyst comprising platinum, rhenium and lanthanum on a high surface area rutile titanium dioxide support wherein said platinum is present at a higher concentration than said rhenium, and said platinum plus said rhenium comprise about 20 wt % of said catalyst.

17. The catalyst of claim 16 wherein said rutile TiO₂ has a surface area greater than about 10 m 2/g.

18. The catalyst of claim 16 wherein said lanthanum is present in the form of La₂O₃ and comprises from about 0.1 wt % up to about 20 wt % of the catalyst.

19. The catalyst of claim 16 wherein said platinum to rhenium ratio is from about 1 Pt:0.9 Re to about 5 Pt:1 Re.

20. The catalyst of claim 16 further comprising an additive selected from the group consisting of cerium, molybdenum, zirconium, tungsten and a combination thereof and wherein said additive is present at a concentration of up to about ______ wt % in the catalyst.
